(19) United States
(12) Patent Application Publication
(10) Pub. No.: US 2024/0169439 A1
(43) Pub. Date: May 23, 2024

(54) SYSTEM AND METHOD FOR VALIDATING A PRICE CALCULATION

(71) Applicant: The Toronto-Dominion Bank, Toronto (CA)

(72) Inventor: Zeeshan FAROOQ, Toronto (CA)

(21) Appl. No.: 17/992,310

(22) Filed: Nov. 22, 2022

(51) Int. Cl. G06Q 40/08

(52) U.S. Cl. CPC G06Q 40/08

(57) ABSTRACT

Computing platforms, methods, and storage media for validating a price calculation, such as a premium calculation, are disclosed. Exemplary implementations may: obtain, from a rating system configured for calculating premiums, a rating system premium calculation based on a plurality of profiles and on a stored set of rate factors; independently calculate a local system premium calculation based on the plurality of profiles and based on a current set of rate factors associated with calculating premiums; and automatically validate the rating system premium calculation based on comparing the rating system premium calculation with the local system premium calculation.

### FIELD

The present disclosure relates to computing systems, including but not limited to computing platforms, methods, and storage media for validating a calculation, such as a price calculation.

### BACKGROUND

A price or premium is typically calculated based on a number of different variables, which may include a number of different ratings. A company offering a service may use one or more third party providers to assist in calculating ratings, prices, and premiums.

Accurate pricing is important in many instances, for example in the insurance industry. According to known approaches, an actuary manually validates the pricing of insurance premiums. This can become unmanageable when there are more than 1 million insurance profiles and premiums requiring validation. A small error, which can propagate to a number of different insurance premium calculations, may result in hundreds of thousands of dollars in difference before it is corrected.

Improvements in approaches for validating a price calculation are desirable.

### BRIEF DESCRIPTION OF THE DRAWINGS

Embodiments of the present disclosure will now be described, by way of example only, with reference to the attached Figures.

FIG. 1 illustrates a system for validating a price calculation, in accordance with one or more embodiments.

FIG. 2 illustrates another system for validating a price calculation, in accordance with one or more embodiments.

FIG. 3 illustrates a method for validating a price calculation, in accordance with one or more embodiments.

FIG. 4 illustrates a system for validating a price calculation, in accordance with one or more embodiments.

FIG. 5 illustrates elements associated with a method of validating an insurance rating determination for an example auto insurance policy, in accordance with one or more example embodiments.

FIG. 6 illustrates results of a comparison between internal and external insurance rating calculations, in accordance with one or more example embodiments.

FIG. 7 illustrates an end-to-end flow example of both a functional flow and automatic validations, in accordance with one or more embodiments.

### DETAILED DESCRIPTION

Computing platforms, methods, and storage media for validating a price calculation, such as a premium calculation, are disclosed. Exemplary implementations may: obtain, from a rating system configured for calculating premiums, a rating system premium calculation based on a plurality of profiles and on a stored set of rate factors; independently calculate a local system premium calculation based on the plurality of profiles and based on a current set of rate factors associated with calculating premiums; and automatically validate the rating system premium calculation based on comparing the rating system premium calculation with the local system premium calculation.

The present disclosure provides validation of a price calculation, such as a rating/premium calculation, to determine whether data entered by a service provider at a third party, such as a rating system, is correct and validated.

According to one or more embodiments, a tool provides automatic rate validation for a third-party rating system. A service provider system may provide rate information to the rating system, and the rating system uses the rate information provided by the service provider to calculate a premium. Embodiments of the present disclosure validate the rate information provided by the service provider by running a parallel calculation on an internal rate calculator, and comparing the internal rate calculator output with an output from the rating system. If the comparison results in a difference, this may be flagged so that the rate information provided to the rating system by the service provider can be corrected/updated.

One aspect of the present disclosure relates to a computing platform configured for validating a price calculation. The computing platform may include a non-transient computer-readable storage medium having executable instructions embodied thereon. The computing platform may include one or more hardware processors configured to execute the instructions. The processor(s) may execute the instructions to obtain, from a rating system configured for calculating premiums, a rating system premium calculation based on a plurality of profiles and on a stored set of rate factors. The processor(s) may execute the instructions to independently calculate a local system premium calculation based on the plurality of profiles and based on a current set of rate factors associated with calculating premiums. The processor(s) may execute the instructions to automatically validate the rating system premium calculation based on comparing the rating system premium calculation with the local system premium calculation.

Another aspect of the present disclosure relates to a method for validating a price calculation. The method may include obtaining, from a rating system configured for calculating premiums, a rating system premium calculation based on a plurality of profiles and on a stored set of rate factors. The method may include independently calculating a local system premium calculation based on the plurality of profiles and based on a current set of rate factors associated with calculating premiums. The method may include automatically validating the rating system premium calculation based on comparing the rating system premium calculation with the local system premium calculation.

Yet another aspect of the present disclosure relates to a non-transient computer-readable storage medium having instructions embodied thereon, the instructions being executable by one or more processors to perform a method for validating a price calculation. The method may include obtaining, from a rating system configured for calculating premiums, a rating system premium calculation based on a plurality of profiles and on a stored set of rate factors. The method may include independently calculating a local system premium calculation based on the plurality of profiles and based on a current set of rate factors associated with calculating premiums. The method may include automatically validating the rating system premium calculation based on comparing the rating system premium calculation with the local system premium calculation.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

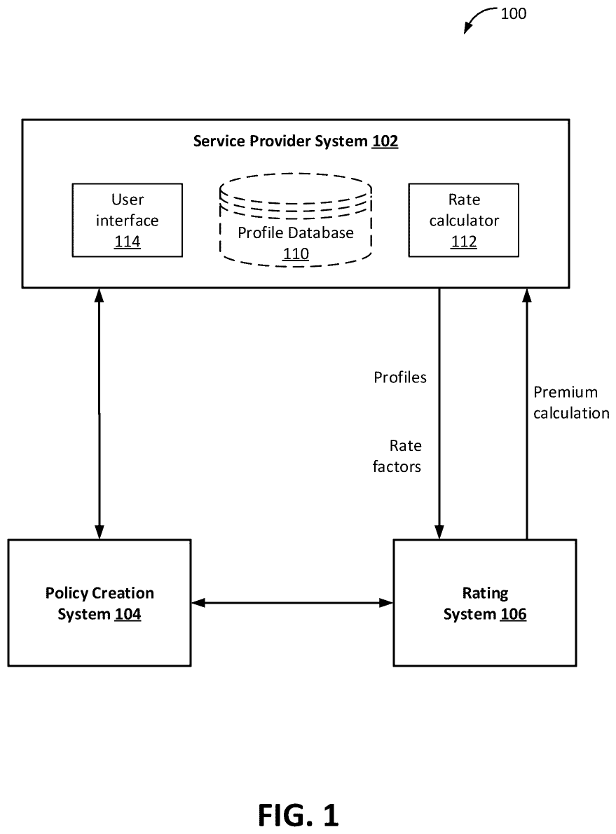

FIG. 1 illustrates a system 100 for validating a calculation, such as a price calculation, in accordance with one or more embodiments. In an example implementation, the price calculation may be an insurance premium calculation. The system 100 comprises a service provider system 102 associated with a service provider. In an example implementation, the service provider system may comprise an insurance provider system associated with a company that provides insurance services and policies to consumers, including individual customers and groups. Service provider system 102 may cooperate with one or more third party providers with respect to the price calculation, for example with a rating system, a pricing system and/or a quote creation system.

In an example scenario where the service provider is an insurance provider, the insurance provider system may cooperate with two third party providers in preparing an insurance premium/quote: a policy creation system 104 and a rating system 106. The policy creation system 104 may be a platform used to issue an insurance policy. An example of a policy creation system is the GuideWire (GW) platform used by many insurance companies. In another embodiment, the policy creation system 104 may be replaced with another system, such as a pricing system or a quote creation system. The rating system 106 may be a rating platform in which the insurance provider enters profiles and/or rating data, which may include a rating, rules and underwriting system or platform. An example of a rating system or platform is Insbridge.

A rating may be used to calculate a price, for example to calculate an insurance premium based on the information and coverages provided. For example, if a customer has an automobile policy and a secondary driver, but the secondary driver has convictions or has a claim history, all of this information needs to be sent to the rating system 106. The rating system 106 may be a product rating platform including a plurality of different rate factors. There may be many factors determining the premium. An insurance provider does not typically directly calculate the premium.

A service provider, or the service provider system 102, may calculate a plurality of rate factors, for example based on instructions or data from an actuary associated with the insurance provider. The service provider system 102 may provide rate information to the rating system 106. The rate information may include a plurality of profiles and a set of rate factors. The profiles may be obtained from a profile database 110 associated with the service provider system 102. The rating system 106 may apply the configured rate factors to determine the actual premium for each line item. The premium may be sent back to the service provider system 102 and, in the case of an insurance provider system, may send the information to the policy creation system 104 to create the policy.

According to one or more embodiments of the present disclosure, the service provider system 102 may compare the entire process against the output of a rate calculator 112, so that the result from the internal rate calculator 112 is compared with the result based on the calculation from the rating system 106.

Embodiments of the present disclosure may validate the rate information provided by the service provider system 102 to the rating system 106 by running a parallel calculation on the internal rate calculator 112, and comparing the two outputs. If the comparison results in a difference, this may be flagged so that the rate information provided by the service provider system 102 to the rating system 106 can be corrected/updated.

The service provider system 102 may be configured to independently calculate a local system premium calculation based on the plurality of profiles and based on a current set of rate factors associated with calculating premiums. In an embodiment, the plurality of profiles comprise a plurality of insurance profiles and the premium calculation is based on a current set of rate factors associated with calculating insurance premiums. The rate calculator 112 may be configured to perform the local system premium calculation. The service provider system 102 may further be configured to automatically validate the rating system premium calculation based on comparing the rating system premium calculation with the local system premium calculation. The service provider system 102 may be configured to, for each of a plurality of rating system premium calculations, periodically and automatically independently calculate the local system premium calculation and automatically validate the rating system premium calculation.

In an example implementation, the service provider system 102 validates the ratings that the service provider enters into the rating system 106 for the purpose of premium calculations, as compared to the service provider information that is stored internally at the service provider system 102. Embodiments of the present disclosure compare the rating system-generated premium to an internal premium generated by the service provider, which helps the service provider to know whether the data entered by the service provider at the rating system 106 is correct and validated.

Pricing is important with respect to pricing, for example with respect to insurance policies and insurance premiums, and any changes are very impactful. In one example implementation, embodiments of the present disclosure may save about $2M by identifying errors in premium calculation, especially where the calculated premium is less than it should have been. In the case where the calculated premium is more than it should have been, embodiments of the present disclosure can help with customer satisfaction and with business retention, by ensuring that customers are provided with the lowest competitive premium based on the insurance provider's advanced calculations.

When comparing the rating system premium calculation with the local system premium calculation, embodiments of the present disclosure may identify that the two calculations do not match. In such an instance, it is desirable to obtain further information about the cause of the mismatch. The service provider system 102 may be configured to identify one or more differences between the rating system premium calculation and the local system premium calculation, and to flag the one or more differences for correction. In another implementation, the service provider system 102 may be configured to identify a difference between a selected rating system premium calculation component and a corresponding local system premium calculation component, and to flag the selected rating system premium calculation component and the corresponding local system premium calculation component for correction.

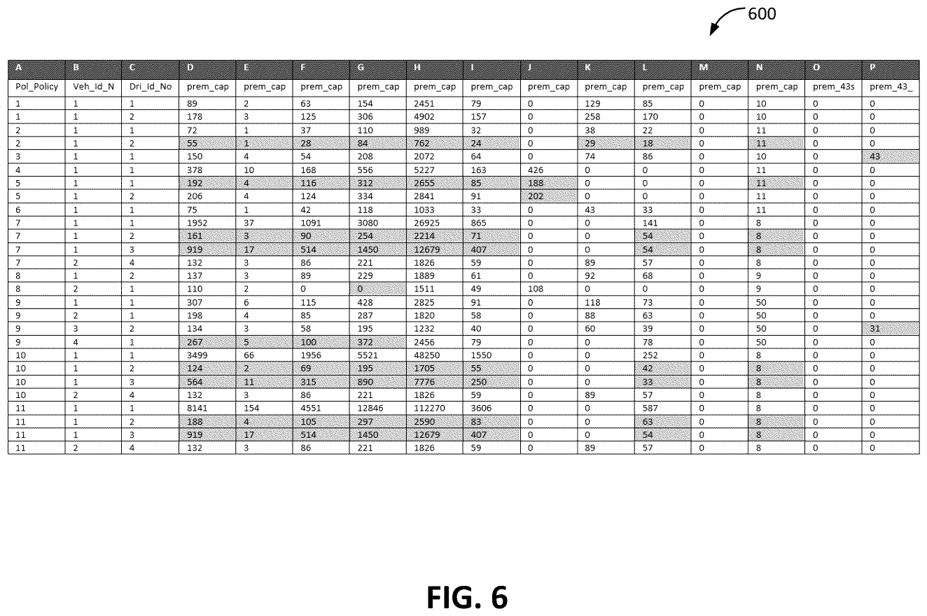

The service provider system 102 may be configured to generate a set of comparison results based on comparing the rating system premium calculation with the local system premium calculation. The service provider system 102 may be configured to provide a user interface 114 displaying validation results based on the generated set of comparison results. Comparison results or validation results will be described later in relation to FIG. 6.

In some instances, an error may occur in one or more of the following scenarios: when a service provider's agent enters information into the policy creation system 104; when the policy creation system 104, which may be referred to as the application layer, sends information to the rating system 106; when a technical team associated with the service provider enters information into the rating system 106; or when data is transmitted between the service provider system 102, the policy creation system 104 and/or the rating system 106. It is desirable to identify occurrence of such errors, so that they may be corrected.

The service provider system 102 may be configured to capture and verify data transmissions between the rating system 106 and another system such as the policy creation system 104, to identify a potential source of a difference between the rating system premium calculation and the local system premium calculation. The local system premium calculation may be performed by the service provider system 102 using the rate calculator 112.

Embodiments of the present disclosure may be configured to capture and verify data transmitted between the service provider system 102, the policy creation system 104, and the rating system 106. This capture and verification of transmitted data assists in identifying where the error may have occurred, for example by comparing a captured transmitted data value to a corresponding expected data value. For example, if a rate factor including a data of birth has an expected data value of 1980-08-15, the system may monitor transmitted data and, when a date of birth value is identified and captured, compare the captured value to the corresponding expected data value. The system may provide a notification or take corrective action to prevent the error from occurring in this way in the future.

In an embodiment, the service provider system 102 comprises an apparatus configured for processing instructions associated with one or more data transfers in the system 100. The apparatus may comprise a non-transient computer-readable storage medium having executable instructions embodied thereon, and one or more hardware processors configured to execute the instructions. The service provider system 102 may be configured to obtain, from the rating system 106 which is configured for calculating premiums, a rating system premium calculation based on a plurality of profiles and on a stored set of rate factors.

The service provider system 102 may be configured to provide, to the rating system 106, the plurality of profiles and the stored set of rate factors. This may be at a point in time that precedes when the service provider system 102 obtains the data from the rating system 106. The plurality of profiles may be stored in the profile database 110 associated with the service provider system 102. In an embodiment, the profile database 110 comprises base profiles for each insurance product in the case of an insurance provider system and a plurality of insurance profiles. In an embodiment, the base profiles may be mapped with data requirements of one or more of the rate calculator(s), the policy creation system 104 and an API associated with the rating system 106.

In an example implementation, the service provider system 102 may be configured to: organize/define a plurality of profiles; inject the profiles into the application layer, which is in communication with the policy creation system 104; obtain premiums from the rating system 106 based on the profiles; capture information going to and from the rating system 106; automatically grab data from a rate calculator, which a business person used to do manually; and use the data to calculate a premium.

In another embodiment, the service provider system 102 may comprise an Excel VBA application for an Actuary to select target products, dates and business. This application may provide one or more of: a visual UI for validation information submission; an environment configuration; integration between Java program for payload and response generation; and integrate with business calculators. Integrating with business calculators may be: for final calculations and premium comparison; using calculator's macros, algorithms and data definitions for premium calculations with database profiles; comparing results; and/or automatically adjusting to changes and field maps in business calculators, allowing business and actuary to independently adjust calculators rate factors.

In a further embodiment, the service provider system 102 may comprise a Java platform configured to perform one or more of the following tasks: develop java platform for following tasks; ingest data from DB for selected products as pre business calculators; develop algorithms to ingest data and format as per InsbridgeAPI payload; will be containing formatter to have same data ingested by GW platforms; convert selected profiles for business calculators of each product province combinations; send payload to insurance bridge, consume response, extract all coverages premium and create output records for business calculators; output for VBA application; check captured payload data mapping with profiles.

Embodiments of the present disclosure may provide a Java and VBA solution, with a Java-based profiles ingestion solution, and a VBA for calculator integration. This may provide a benefit of fast execution, for example using an API based solution to speed up execution.

Embodiments of the present disclosure may provide conditioning, for example using database profiles and creation and algorithms to create rating payload requests consumable by Insbridge API using data from the database and other inputs. This may provide a benefit of efficiency by: providing high scalability in order to achieve maximum efficiency in time and cost; simulating scenarios not currently in production; and covering all possible rate impacting changes.

Embodiments of the present disclosure may provide validation, for example by extracting category premiums for each coverage and other pricing scores for business calculators for auto-verification of premiums. This may provide a benefit of cost avoidance, for example by comparing the actual rate calculator with new GI pricing tool, which allows verification of thousands of profiles within a day.

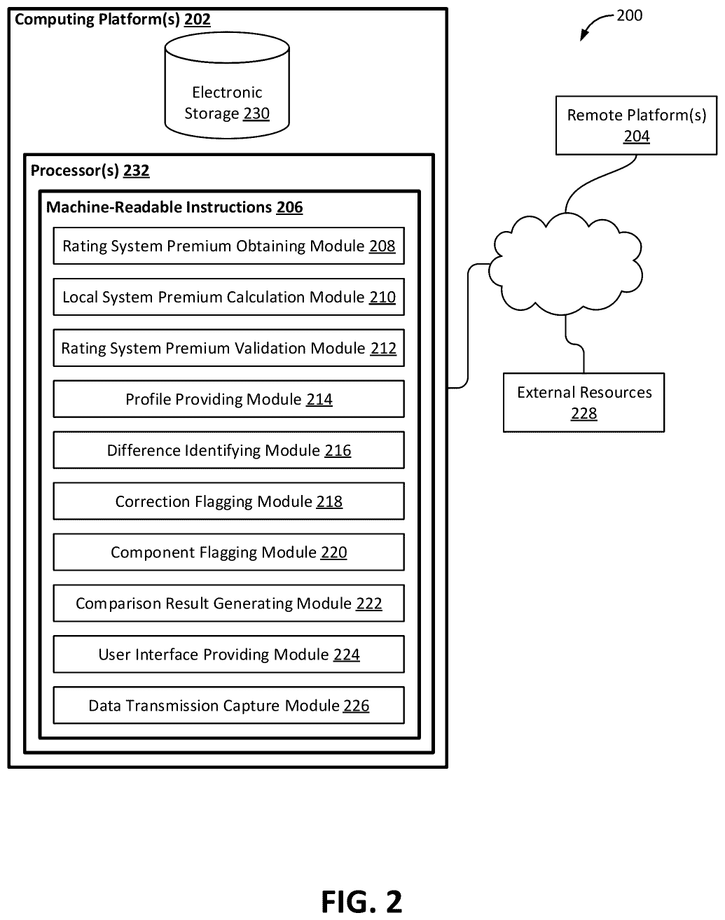

FIG. 2 illustrates another system 200 configured for validating a price calculation, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of rating system premium obtaining module 208, local system premium calculation module 210, rating system premium validation module 212, profile providing module 214, difference identifying module 216, correction flagging module 218, component flagging module 220, comparison result generating module 222, user interface providing module 224, data transmission capture module 226, and/or other instruction modules.

Rating system premium obtaining module 208 may be configured to obtain, from a rating system configured for calculating pricing or premiums, a rating system premium calculation based on a plurality of profiles and on a stored set of rate factors. In an embodiment, rating system premium obtaining module 208 may be configured to obtain, from a rating system configured for calculating insurance premiums, a rating system premium calculation based on a plurality of insurance profiles and on a stored set of rate factors.

Local system premium calculation module 210 may be configured to independently calculate a local system premium calculation based on the plurality of profiles and based on a current set of rate factors associated with calculating premiums. A local system, for example the service provider system, may be configured to perform the local system premium calculation. Local system premium calculation module 210 may be configured to, for each of a plurality of rating system premium calculations, periodically and automatically, independently calculate the local system premium calculation and automatically validating the rating system premium calculation.

Rating system premium validation module 212 may be configured to automatically validate the rating system premium calculation based on comparing the rating system premium calculation with the local system premium calculation.

Profile providing module 214 may be configured to provide, to the rating system, the plurality of profiles and the stored set of rate factors. Profile providing module 214 may comprise an insurance profile providing module configured to provide, to the rating system, the plurality of insurance profiles and the stored rate factors.

Difference identifying module 216 may be configured to identify one or more differences between the rating system premium calculation and the local system premium calculation. Difference identifying module 216 may be configured to identify a difference between a selected rating system premium calculation component and a corresponding local system premium calculation component.

Correction flagging module 218 may be configured to flag the one or more differences for correction.

Component flagging module 220 may be configured to flag the selected rating system premium calculation component and the corresponding local system premium calculation component for correction.

Comparison result generating module 222 may be configured to generate a set of comparison results based on comparing the rating system premium calculation with the local system premium calculation.

User interface providing module 224 may be configured to provide a user interface displaying validation results based on the generated set of comparison results. Displaying the validation results may include displaying a set of failed validations based on the generated set of comparison results. Displaying the validation results may include displaying a set of successful validations and a highlighted set of failed validations based on the generated set of comparison results.

Data transmission capture module 226 may be configured to capture and verify data transmissions between the rating system and another system to identify a potential source of a difference between the rating system premium calculation and the local system premium calculation.

In some embodiments, computing platform(s) 202, remote platform(s) 204, and/or external resources 228 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 228 may be operatively linked via some other communication media.

A given remote platform 204 may include one or more processors configured to execute computer program modules. The computer program modules may be configured to enable an expert or user associated with the given remote platform 204 to interface with system 200 and/or external resources 228, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 228 may include sources of information outside of system 200, external entities participating with system 200, and/or other resources. In some embodiments, some or all of the functionality attributed herein to external resources 228 may be provided by resources included in system 200.

Computing platform(s) 202 may include electronic storage 230, one or more processors 232, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 230 may comprise non-transitory storage media that electronically stores information. The electronic storage media of electronic storage 230 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 230 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 230 may include one or more virtual storage resources (e.g., cloud storage, a virtual private network, and/or other virtual storage resources). Electronic storage 230 may store software algorithms, information determined by processor(s) 232, information received from computing platform(s) 202, information received from remote platform(s) 204, and/or other information that enables computing platform(s) 202 to function as described herein.

Processor(s) 232 may be configured to provide information processing capabilities in computing platform(s) 202. As such, processor(s) 232 may include one or more of a digital processor, an analog processor, a digital circuit designed to process information, an analog circuit designed to process information, a state machine, and/or other mechanisms for electronically processing information. Although processor(s) 232 is shown in FIG. 2 as a single entity, this is for illustrative purposes only. In some embodiments, processor(s) 232 may include a plurality of processing units. These processing units may be physically located within the same device, or processor(s) 232 may represent processing functionality of a plurality of devices operating in coordination. Processor(s) 232 may be configured to execute modules 208, 210, 212, 214, 216, 218, 220, 222, 224, and/or 226, and/or other modules. Processor(s) 232 may be configured to execute modules 208, 210, 212, 214, 216, 218, 220, 222, 224, and/or 226, and/or other modules by software; hardware; firmware; some combination of software, hardware, and/or firmware; and/or other mechanisms for configuring processing capabilities on processor(s) 232. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, and/or 226 are illustrated in FIG. 2 as being implemented within a single processing unit, in embodiments in which processor(s) 232 includes multiple processing units, one or more of modules 208, 210, 212, 214, 216, 218, 220, 222, 224, and/or 226 may be implemented remotely from the other modules. The description of the functionality provided by the different modules 208, 210, 212, 214, 216, 218, 220, 222, 224, and/or 226 described below is for illustrative purposes, and is not intended to be limiting, as any of modules 208, 210, 212, 214, 216, 218, 220, 222, 224, and/or 226 may provide more or less functionality than is described. For example, one or more of modules 208, 210, 212, 214, 216, 218, 220, 222, 224, and/or 226 may be eliminated, and some or all of its functionality may be provided by other ones of modules 208, 210, 212, 214, 216, 218, 220, 222, 224, and/or 226. As another example, processor(s) 232 may be configured to execute one or more additional modules that may perform some or all of the functionality attributed below to one of modules 208, 210, 212, 214, 216, 218, 220, 222, 224, and/or 226.

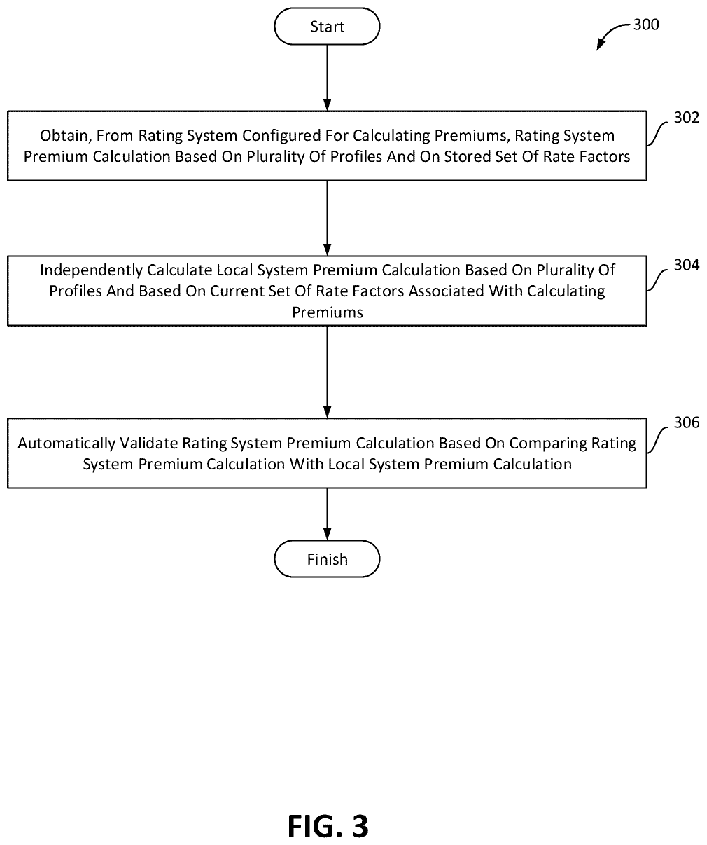

FIG. 3 illustrates a method 300 for validating a price calculation, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining, from a rating system configured for calculating premiums, a rating system premium calculation based on a plurality of profiles and on a stored set of rate factors. In an example embodiment, the premiums may comprise insurance premiums, and the profiles may comprise insurance profiles. Operation 302 may be performed by one or more hardware processors configured by machine-readable instructions including a module that is the same as or similar to rating system premium obtaining module 208, in accordance with one or more embodiments.

An operation 304 may include independently calculating a local system premium calculation based on the plurality of profiles and based on a current set of rate factors associated with calculating premiums. In an example embodiment, the premiums may comprise insurance premiums, and the profiles may comprise insurance profiles. Operation 304 may be performed by one or more hardware processors configured by machine-readable instructions including a module that is the same as or similar to local system premium calculation module 210, in accordance with one or more embodiments.

An operation 306 may include automatically validating the rating system premium calculation based on comparing the rating system premium calculation with the local system premium calculation. Operation 306 may be performed by one or more hardware processors configured by machine-readable instructions including a module that is the same as or similar to rating system premium validation module 212, in accordance with one or more embodiments.

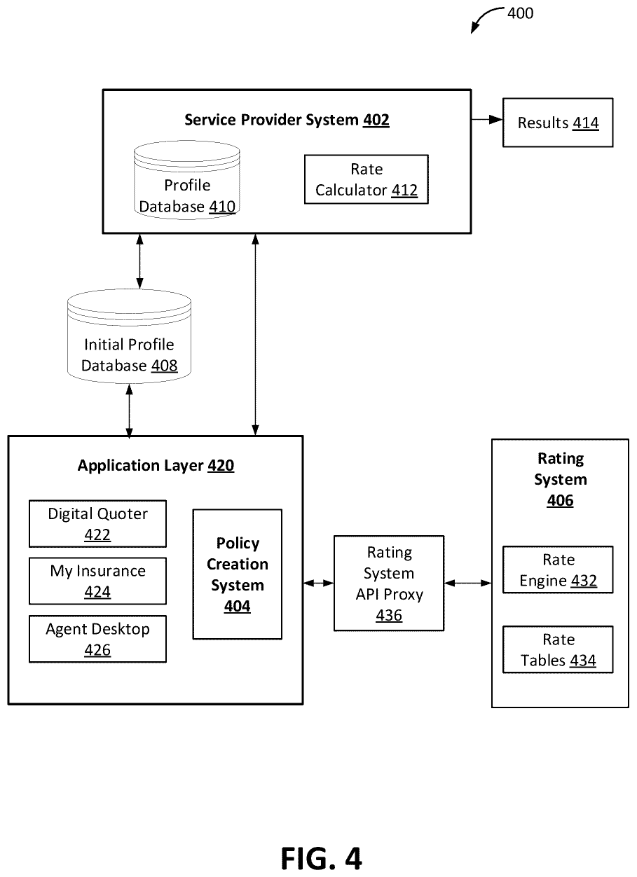

FIG. 4 illustrates a system 400 for validating a price calculation, in accordance with one or more embodiments. FIG. 4 illustrates the interaction between a service provider system 402, an application layer including a policy creation system 404, such as GuideWire, and a rating system 406 or rating platform, such as Insbridge. In an example embodiment, the service provider system 402 comprises an insurance provider system.

According to known approaches, a system would run data through a policy creation system application, such as GuideWire, simulate some profiles, and manually compare profiles with a calculator in a huge Excel spreadsheet. Different calculators may be used, for example for different insurance products. According to embodiments of the present disclosure, the system 400 validates changes happening between the rate calculator 412 and an output of the rating system 406. The rating system 406 may include a rate engine and a plurality of rate tables. If there is a variation/difference, such a difference may be highlighted and/or flagged by the service provider system 402, for example in a results output 414 from the service provider system 402. In an example embodiment, corrective action is not automatically taken, and the system provides results data 414 as an output, which may be used, for example by an actuary, to decide which value is correct, the data from the rating system 406 or the data from the insurance provider system 402.

An initial profile database 408 may be provided to explore data and describe the profiles that may be used in accordance with embodiments of the present disclosure. For example, the database 408 of initial profiles, or test profiles, may be used or generated prior to generating and storing final profiles in a profile database 410. The system 400 may take the initial profile data and provide the data to an application layer 420, including a policy creation system 404, such as GuideWire. The Application Layer may include functionality such as a Digital Quoter 422, a My Insurance module 424, and an Agent Desktop 426. In an embodiment, such functionality may be provided by, or in conjunction with, the policy creation system 404.

The service provider system 402 may cooperate with the initial profile database 408 to organize and create a number of profiles, which may be stored in the profile database 410. The service provider system 402 may obtain and compare the rate/premium calculation from the rating system 406 with the output of the rate calculator 412 which is internal to the service provider system 402. The rating system may include a rate engine 432 and a plurality of rate tables 434.

In performing the comparison, the service provider system 402 may verify an API call from the rating system 406, such as an InsbridgeAPI call with a rating calculator. This may be performed by, using, or in conjunction with, a rating system API proxy 436, so as to validate a request side data-mapping with the application layer 420. The system 400 may also be configured to capture traffic transmitted between the entities involved in the system 400, so that the system 400 captures the payload and the transmission as well. This captured transmitted data traffic may be used to identify a source of an error that caused a difference or discrepancy between the rating system premium calculation and the service provider system premium calculation.

In an example implementation, when an agent associated with a service provider is creating a pricing quote, such as an insurance policy, the agent may be on the phone with a customer. The agent may use an application layer 420 and/or a policy creation system 404 to filling out an application and obtain the premium. To simulate that activity of an agent creating a number of different profiles and obtaining associated premiums, the service provider system 402 may examine the rate factors involved in the insurance premium calculation, and all of the possible data points that impact the rating. The service provider system 402 may generate a profile using each impacted data point (e.g. profile with a 3 year driving license suspension; one car with 4 occasional drivers). To validate these data, the system 402 may organize the profiles in a profile database 410 to organize the data with respect to the policy creation system 404, such as GuideWire.

According to an embodiment of the present disclosure, the system improves data and database information “offline”, so that when an agent is generating a policy in real-time, the proper information and premiums are used.

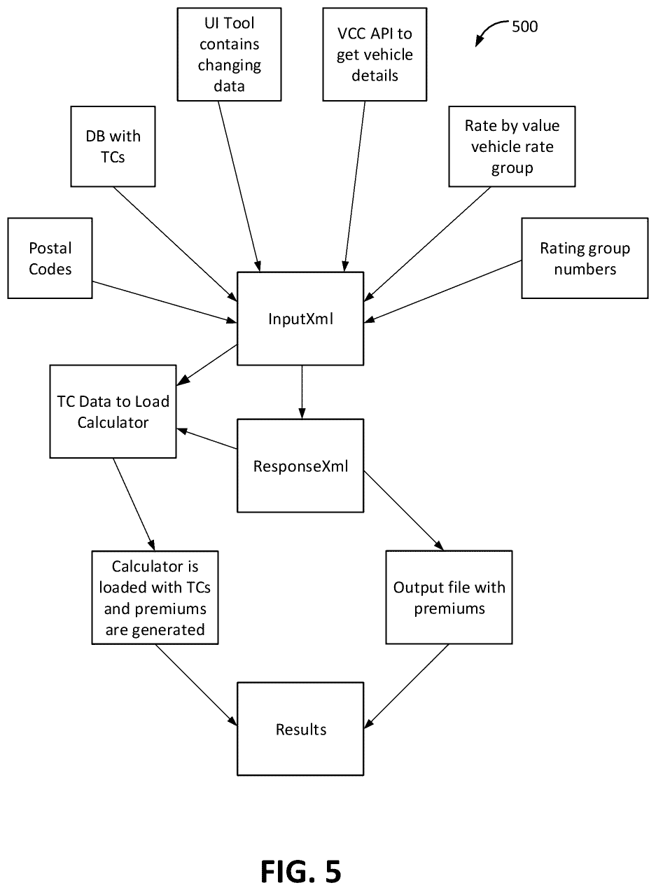

FIG. 5 illustrates elements 500 associated with a method of validating an insurance rating determination for an example auto insurance policy, in accordance with one or more example embodiments. As shown in FIG. 5, a number of factors or rating input data may be provided to an input calculator, shown in FIG. 5 as InputXML. For an example implementation based on an auto insurance policy, the factors that affect the premium and/or the rating(s) may include: postal codes; vehicle details; debate details; rating group numbers. As shown in FIG. 5, the method uses this data and may provide this data to a rating platform such as Insbridge, for example shown as ResponseXML in FIG. 5. An internal calculator of an insurance provider system uses this data to generate premiums, and in parallel the rating system outputs a file with premiums. Both of these generated premiums from the two systems are compared, and the results are generated, as shown at the bottom of FIG. 5, flagging any differences for further investigation so as to ensure that the proper data is being used in the calculations or determinations.

FIG. 6 illustrates results 600 of a comparison between internal and external insurance rating calculations, in accordance with one or more example embodiments. The output may, for example, be based on a results output 414 in FIG. 4, in accordance with one or more embodiments. The output may, for example, be based on an output of the last step in FIG. 5, in accordance with one or more embodiments. In an example implementation, the system may take a massive set of code and outputs from the rating system, which output is not very understandable, and create a results output 600 as shown in FIG. 6. The results output 600 may be provided by, or via, a user interface associated with the service provider system.

The results output may display validation results based on the generated set of comparison results. In the example embodiment of FIG. 6, the results output 600 displays a set of successful validations and a highlighted set of failed validations, based on the generated set of comparison results. In other implementations, the failed validations may be emphasized or highlighted in a different manner. In another embodiment, the results output may include displaying a set of failed validations based on the generated set of comparison results, and in a further embodiment may include only displaying a set of failed validations based on the generated set of comparison results. The system may generate a “failing tests” sheet, which outlines each difference individually, or which integrates these failing tests within the same sheet with highlighting, as shown in FIG. 6.

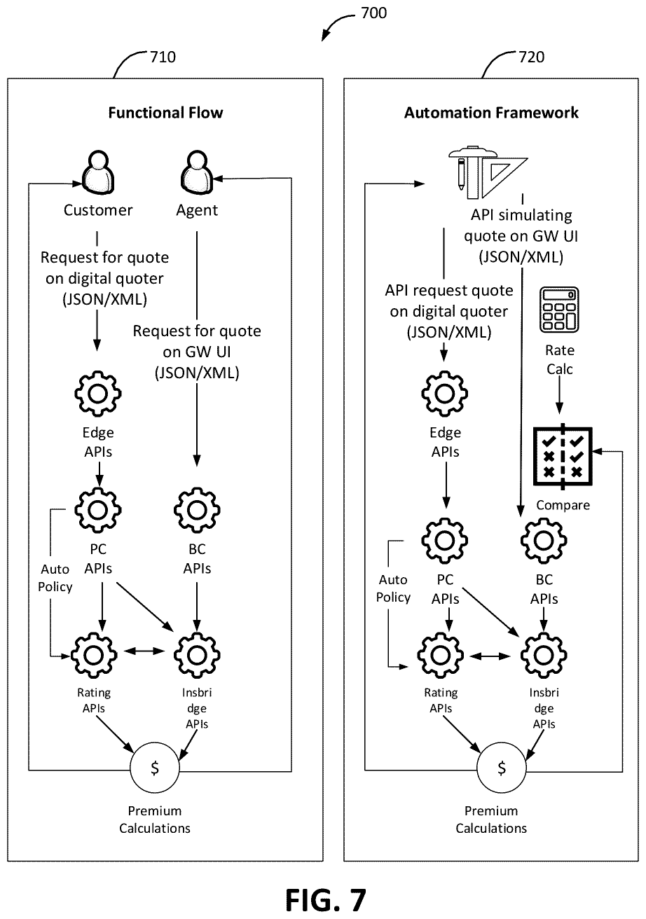

FIG. 7 illustrates an end-to-end flow example of both a functional flow and automatic validations, in accordance with one or more embodiments. The examples of FIG. 7 show examples of how edge APIs, business calculator APIs and PC APIs may be configured to interact with rating APIs and Insbridge APIs to perform premium calculations, and to compare the results with the results from a business calculator.

The present disclosure provides validation of a price calculation, such as an insurance rating/premium calculation, to determine whether data entered by a service provider at a third party, such as a rating system, is correct and validated. Embodiments of the present disclosure validate the rate information provided by the service provider by running a parallel calculation on an internal rate calculator, and comparing the internal rate calculator output with an output from the rating system. If the comparison results in a difference, this is flagged so that the rate information provided to the rating system by the service provider can be corrected/updated.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for validating a price calculation. The system may include one or more hardware processors configured by machine-readable instructions. The processor(s) may be configured to obtain, from a rating system configured for calculating premiums, a rating system premium calculation based on a plurality of profiles and on a stored set of rate factors. The processor(s) may be configured to independently calculate a local system premium calculation based on the plurality of profiles and based on a current set of rate factors associated with calculating premiums. The processor(s) may be configured to automatically validate the rating system premium calculation based on comparing the rating system premium calculation with the local system premium calculation. In an example embodiment, the system may be configured for validating a price calculation such as an insurance premium calculation, where the premiums may comprise insurance premiums, and the profiles may comprise insurance profiles.

In some implementations of the system, the processor(s) may be configured to provide, to the rating system, the plurality of profiles and the stored set of rate factors.

In some implementations of the system, the processor(s) may be configured to identify one or more differences between the rating system premium calculation and the local system premium calculation. In some implementations of the system, the processor(s) may be configured to flag the one or more differences for correction.

In some implementations of the system, the processor(s) may be configured to identify a difference between a selected rating system premium calculation component and a corresponding local system premium calculation component. In some implementations of the system, the processor(s) may be configured to flag the selected rating system premium calculation component and the corresponding local system premium calculation component for correction.

In some implementations of the system, the processor(s) may be configured to generate a set of comparison results based on comparing the rating system premium calculation with the local system premium calculation.

In some implementations of the system, the processor(s) may be configured to provide a user interface displaying validation results based on the generated set of comparison results.

In some implementations of the system, displaying the validation results may include displaying a set of failed validations based on the generated set of comparison results.

In some implementations of the system, displaying the validation results may include displaying a set of successful validations and a highlighted set of failed validations based on the generated set of comparison results.

In some implementations of the system, the processor(s) may be configured to, for each of a plurality of rating system premium calculations, periodically and automatically, independently calculate the local system premium calculation and automatically validating the rating system premium calculation.

In some implementations of the system, the processor(s) may be configured to capture and verifying data transmissions between the rating system and another system to identify a potential source of a difference between the rating system premium calculation and the local system premium calculation.

In some implementations of the system, the other system may include a local system configured to perform the local system premium calculation.

In some implementations of the system, the other system may include a policy platform configured for communication with the rating system or with a local system configured to perform the local system premium calculation.

Another aspect of the present disclosure relates to a method for validating a price calculation. The method may include obtaining, from a rating system configured for calculating premiums, a rating system premium calculation based on a plurality of profiles and on a stored set of rate factors. The method may include independently calculating a local system premium calculation based on the plurality of profiles and based on a current set of rate factors associated with calculating premiums. The method may include automatically validating the rating system premium calculation based on comparing the rating system premium calculation with the local system premium calculation. In an example embodiment, validating a price calculation may comprise validating an insurance premium calculation, where the premiums may comprise insurance premiums, and the profiles may comprise insurance profiles.

In some implementations of the method, it may include providing, to the rating system, the plurality of profiles and the stored set of rate factors.

In some implementations of the method, it may include identifying one or more differences between the rating system premium calculation and the local system premium calculation. In some implementations of the method, it may include flagging the one or more differences for correction.

In some implementations of the method, it may include identifying a difference between a selected rating system premium calculation component and a corresponding local system premium calculation component. In some implementations of the method, it may include flagging the selected rating system premium calculation component and the corresponding local system premium calculation component for correction.

In some implementations of the method, it may include generating a set of comparison results based on comparing the rating system premium calculation with the local system premium calculation.

In some implementations of the method, it may include providing a user interface displaying validation results based on the generated set of comparison results.

In some implementations of the method, displaying the validation results may include displaying a set of failed validations based on the generated set of comparison results.

In some implementations of the method, displaying the validation results may include displaying a set of successful validations and a highlighted set of failed validations based on the generated set of comparison results.

In some implementations of the method, it may include, for each of a plurality of rating system premium calculations, periodically and automatically, independently calculating the local system premium calculation and automatically validating the rating system premium calculation.

In some implementations of the method, it may include capturing and verifying data transmissions between the rating system and another system to identify a potential source of a difference between the rating system premium calculation and the local system premium calculation.

In some implementations of the method, the other system may include a local system configured to perform the local system premium calculation.

In some implementations of the method, the other system may include a policy platform configured for communication with the rating system or with a local system configured to perform the local system premium calculation.

Yet another aspect of the present disclosure relates to a non-transient computer-readable storage medium having instructions embodied thereon, the instructions being executable by one or more processors to perform a method for validating a price calculation. The method may include obtaining, from a rating system configured for calculating premiums, a rating system premium calculation based on a plurality of profiles and on a stored set of rate factors. The method may include independently calculating a local system premium calculation based on the plurality of profiles and based on a current set of rate factors associated with calculating premiums. The method may include automatically validating the rating system premium calculation based on comparing the rating system premium calculation with the local system premium calculation. In an example embodiment, validating a price calculation may comprise validating an insurance premium calculation, where the premiums may comprise insurance premiums, and the profiles may comprise insurance profiles.

In some implementations of the computer-readable storage medium, the method may include providing, to the rating system, the plurality of profiles and the stored set of rate factors.

In some implementations of the computer-readable storage medium, the method may include identifying one or more differences between the rating system premium calculation and the local system premium calculation. In some implementations of the computer-readable storage medium, the method may include flagging the one or more differences for correction.

In some implementations of the computer-readable storage medium, the method may include identifying a difference between a selected rating system premium calculation component and a corresponding local system premium calculation component. In some implementations of the computer-readable storage medium, the method may include flagging the selected rating system premium calculation component and the corresponding local system premium calculation component for correction.

In some implementations of the computer-readable storage medium, the method may include generating a set of comparison results based on comparing the rating system premium calculation with the local system premium calculation.

In some implementations of the computer-readable storage medium, the method may include providing a user interface displaying validation results based on the generated set of comparison results.

In some implementations of the computer-readable storage medium, displaying the validation results may include displaying a set of failed validations based on the generated set of comparison results.

In some implementations of the computer-readable storage medium, displaying the validation results may include displaying a set of successful validations and a highlighted set of failed validations based on the generated set of comparison results.

In some implementations of the computer-readable storage medium, the method may include, for each of a plurality of rating system premium calculations, periodically and automatically, independently calculating the local system premium calculation and automatically validating the rating system premium calculation.

In some implementations of the computer-readable storage medium, the method may include capturing and verifying data transmissions between the rating system and another system to identify a potential source of a difference between the rating system premium calculation and the local system premium calculation.

In some implementations of the computer-readable storage medium, the other system may include a local system configured to perform the local system premium calculation.

In some implementations of the computer-readable storage medium, the other system may include a policy platform configured for communication with the rating system or with a local system configured to perform the local system premium calculation.

Still another aspect of the present disclosure relates to a system configured for validating a price calculation. The system may include means for obtaining, from a rating system configured for calculating premiums, a rating system premium calculation based on a plurality of profiles and on a stored set of rate factors. The system may include means for independently calculating a local system premium calculation based on the plurality of profiles and based on a current set of rate factors associated with calculating premiums. The system may include means for automatically validating the rating system premium calculation based on comparing the rating system premium calculation with the local system premium calculation. In an example embodiment, the system may be configured for validating a price calculation such as an insurance premium calculation, where the premiums may comprise insurance premiums, and the profiles may comprise insurance profiles.

In some implementations of the system, the system may include means for providing, to the rating system, the plurality of profiles and the stored set of rate factors.

In some implementations of the system, the system may include means for identifying one or more differences between the rating system premium calculation and the local system premium calculation. In some implementations of the system, the system may include means for flagging the one or more differences for correction.

In some implementations of the system, the system may include means for identifying a difference between a selected rating system premium calculation component and a corresponding local system premium calculation component. In some implementations of the system, the system may include means for flagging the selected rating system premium calculation component and the corresponding local system premium calculation component for correction.

In some implementations of the system, the system may include means for generating a set of comparison results based on comparing the rating system premium calculation with the local system premium calculation.

In some implementations of the system, the system may include means for providing a user interface displaying validation results based on the generated set of comparison results.

In some implementations of the system, displaying the validation results may include displaying a set of failed validations based on the generated set of comparison results.

In some implementations of the system, displaying the validation results may include displaying a set of successful validations and a highlighted set of failed validations based on the generated set of comparison results.

In some implementations of the system, the system may include means for, for each of a plurality of rating system premium calculations, periodically and automatically, independently calculating the local system premium calculation and automatically validating the rating system premium calculation.

In some implementations of the system, the system may include means for capturing and verifying data transmissions between the rating system and another system to identify a potential source of a difference between the rating system premium calculation and the local system premium calculation.

In some implementations of the system, the other system may include a local system configured to perform the local system premium calculation.

In some implementations of the system, the other system may include a policy platform configured for communication with the rating system or with a local system configured to perform the local system premium calculation.

Even another aspect of the present disclosure relates to a computing platform configured for validating a price calculation. The computing platform may include a non-transient computer-readable storage medium having executable instructions embodied thereon. The computing platform may include one or more hardware processors configured to execute the instructions. The processor(s) may execute the instructions to obtain, from a rating system configured for calculating premiums, a rating system premium calculation based on a plurality of profiles and on a stored set of rate factors. The processor(s) may execute the instructions to independently calculate a local system premium calculation based on the plurality of profiles and based on a current set of rate factors associated with calculating premiums. The processor(s) may execute the instructions to automatically validate the rating system premium calculation based on comparing the rating system premium calculation with the local system premium calculation. In an example embodiment, the system may be configured for validating a price calculation such as an insurance premium calculation, where the premiums may comprise insurance premiums, and the profiles may comprise insurance profiles.

In some implementations of the computing platform, the processor(s) may execute the instructions to provide, to the rating system, the plurality of profiles and the stored set of rate factors.

In some implementations of the computing platform, the processor(s) may execute the instructions to identify one or more differences between the rating system premium calculation and the local system premium calculation. In some implementations of the computing platform, the processor(s) may execute the instructions to flag the one or more differences for correction.

In some implementations of the computing platform, the processor(s) may execute the instructions to identify a difference between a selected rating system premium calculation component and a corresponding local system premium calculation component. In some implementations of the computing platform, the processor(s) may execute the instructions to flag the selected rating system premium calculation component and the corresponding local system premium calculation component for correction.

In some implementations of the computing platform, the processor(s) may execute the instructions to generate a set of comparison results based on comparing the rating system premium calculation with the local system premium calculation.

In some implementations of the computing platform, the processor(s) may execute the instructions to provide a user interface displaying validation results based on the generated set of comparison results.

In some implementations of the computing platform, displaying the validation results may include displaying a set of failed validations based on the generated set of comparison results.

In some implementations of the computing platform, displaying the validation results may include displaying a set of successful validations and a highlighted set of failed validations based on the generated set of comparison results.

In some implementations of the computing platform, the processor(s) may execute the instructions to, for each of a plurality of rating system premium calculations, periodically and automatically, independently calculate the local system premium calculation and automatically validating the rating system premium calculation.

In some implementations of the computing platform, the processor(s) may execute the instructions to capture and verifying data transmissions between the rating system and another system to identify a potential source of a difference between the rating system premium calculation and the local system premium calculation.

In some implementations of the computing platform, the other system may include a local system configured to perform the local system premium calculation.

In some implementations of the computing platform, the other system may include a policy platform configured for communication with the rating system or with a local system configured to perform the local system premium calculation.

What is claimed is:

1. An apparatus configured for processing instructions associated with one or more data transfers in a system, the apparatus comprising:
a non-transient computer-readable storage medium having executable instructions embodied thereon; and
one or more hardware processors configured to execute the instructions to:
obtain, from a rating system configured for calculating premiums, a rating system premium calculation based on a plurality of profiles and on a stored set of rate factors;
independently calculate a local system premium calculation based on the plurality of profiles and based on a current set of rate factors associated with calculating premiums; and
automatically validate the rating system premium calculation based on comparing the rating system premium calculation with the local system premium calculation.

2. The apparatus of claim 1 wherein the one or more hardware processors are further configured to execute the instructions to:
provide, to the rating system, the plurality of profiles and the stored set of rate factors.

3. The apparatus of claim 1 wherein the one or more hardware processors are further configured to execute the instructions to:
identify one or more differences between the rating system premium calculation and the local system premium calculation; and
flag the one or more differences for correction.

4. The apparatus of claim 1 wherein the one or more hardware processors are further configured to execute the instructions to:
identify a difference between a selected rating system premium calculation component and a corresponding local system premium calculation component; and
flag the selected rating system premium calculation component and the corresponding local system premium calculation component for correction.

5. The apparatus of claim 1 wherein the one or more hardware processors are further configured to execute the instructions to:
generate a set of comparison results based on comparing the rating system premium calculation with the local system premium calculation.

6. The apparatus of claim 5 wherein the one or more hardware processors are further configured to execute the instructions to:
provide a user interface displaying validation results based on the generated set of comparison results.

7. The apparatus of claim 1 wherein the one or more hardware processors are further configured to execute the instructions to, for each of a plurality of rating system premium calculations:
periodically and automatically independently calculate the local system premium calculation and automatically validate the rating system premium calculation.

8. The apparatus of claim 1 wherein the one or more hardware processors are further configured to execute the instructions to:
capture and verify data transmissions between the rating system and an other system to identify a potential source of a difference between the rating system premium calculation and the local system premium calculation.

9. The apparatus of claim 1 wherein the premiums comprise insurance premiums and the profiles comprise insurance profiles.

10. A processor-implemented method of validating a premium calculation comprising:
obtaining, from a rating system configured for calculating premiums, a rating system premium calculation based on a plurality of profiles and on a stored set of rate factors;
independently calculating a local system premium calculation based on the plurality of profiles and based on a current set of rate factors associated with calculating premiums; and
automatically validating the rating system premium calculation based on comparing the rating system premium calculation with the local system premium calculation.

11. The method of claim 10, further comprising:
providing, to the rating system, the plurality of profiles and the stored set of rate factors.

12. The method of claim 10, further comprising:
identifying one or more differences between the rating system premium calculation and the local system premium calculation; and
flagging the one or more differences for correction.

13. The method of claim 10, further comprising:
identifying a difference between a selected rating system premium calculation component and a corresponding local system premium calculation component; and
flagging the selected rating system premium calculation component and the corresponding local system premium calculation component for correction.

14. The method of claim 10, further comprising:
generating a set of comparison results based on comparing the rating system premium calculation with the local system premium calculation.

15. The method of claim 14, further comprising:
providing a user interface displaying validation results based on the generated set of comparison results.

16. The method of claim 10, further comprising, for each of a plurality of rating system premium calculations:
periodically and automatically independently calculating the local system premium calculation and automatically validating the rating system premium calculation.

17. The method of claim 10, further comprising:
capturing and verifying data transmissions between the rating system and an other system to identify a potential source of a difference between the rating system premium calculation and the local system premium calculation.

18. The method of claim 17 wherein the premiums comprise insurance premiums and the profiles comprise insurance profiles.

19. A non-transient computer-readable storage medium having instructions embodied thereon, the instructions being executable by one or more processors to perform a method of validating an premium calculation, the method comprising:
obtaining, from a rating system configured for calculating premiums, a rating system premium calculation based on a plurality of profiles and on a stored set of rate factors;
independently calculating a local system premium calculation based on the plurality of profiles and based on a current set of rate factors associated with calculating premiums; and
automatically validating the rating system premium calculation based on comparing the rating system premium calculation with the local system premium calculation.

20. The non-transient computer-readable storage medium of claim 19 wherein the method further comprises:
providing a user interface displaying validation results based on a generated set of comparison results, the generated set of comparison results being based on comparing the rating system premium calculation with the local system premium calculation.
